(19) United States
(12) Patent Application Publication
(10) Pub. No.: US 2009/0237681 A1
(43) Pub. Date: Sep. 24, 2009

(54) METHOD FOR ENCODING RENDERING HINTS INTO A BITMAP IMAGE

(75) Inventor: Andrew R. Ferlitsch, Camas, WA (US)

Correspondence Address: Stolowitz Ford Cowger LLP/Sharp, 621 SW Morrison St, Suite 600, Portland, OR, 97205, US

(73) Assignee: Sharp laboratories of America, Inc., Camas, WA (US)

(21) Appl. No.: 12/051,817

(22) Filed: Mar. 19, 2008

(51) Int. Cl. G06K 1/00

(52) U.S. Cl. 358/1.9

(57) ABSTRACT

Methods, systems and software are disclosed for embedding and using rendering hints in a bitmap image. Print objects (204)(304) are determined by an application (202)(302). In a modified bitmap driver process (208)(308), internal objects are formed, and rendering hints are assigned to each internal object (410). These rendering hints are embedded in the output bitmap image (210)(310) without increasing its size by reusing selected bit planes (314)(440). Output quality is maintained by reusing the least significant bit planes and then masking those planes (622) during the output device (firmware) RIP process (630).

### RELATED APPLICATIONS

None.

### TECHNICAL FIELD

This invention pertains to methods and apparatus for digital document processing and, more specifically, to improvements in the use of rendering hints in a color printing process or system.

### BACKGROUND OF THE INVENTION

The adjustment of color-rendering techniques for different types of graphics is a common feature available in document and imaging software applications and printer drivers. For example, a user may prefer that their business graphics be rendered more vibrantly than the default setting, or bitmaps made more realistic. Also, scanned halftoned images may need to be de-screened when printed, if the printer also uses halftoning. Further, some users may prefer that computer-generated bitmaps be rendered more vibrant than the default setting, while digital photographs be rendered more realistically.

One conventional mechanism permits rendering options to be selected, within any file, on the basis of the class of the graphics. U.S. Pat. No. 5,704,021, assigned to HP, describes a process that permits a user to select a color rendering option on the basis of object type. The primary limitation of this process is that the same rendering process must be applied to all members of the class. For example, if a user selects a particular rendering option for a photo, that same rendering parameters are applied to all photos in the file. Further, there are only three object types. The classes (object types) provided in this HP patent are “Graphics, Photo, and Text”.

Other improvements are known for customizing and correcting the color rendering of a hardcopy document processed by a printer. For example, commonly-assigned U.S. Patent Application Publication No. 2006/0017955 (Jan. 26, 2006) permits custom rendering options to be applied to graphic instances in any type of image processing application.

FIG. 1a is a simplified illustration of one known method of using rendering hints. In FIG. 1a, an application program or process 102 receives or creates an input digital document 100, typically comprising one or more sequential pages. In operation, for example in preparing the document for printing, the application outputs the document data as a set of elements 104 such as graphical primitive elements. A printer driver such as a PDL Driver 106 receives the primitive objects and classifies each of the document objects into different rendering classes (e.g., photographic vs. business graphics, text, etc.). This methodology then uses different rendering methods or parameters to optimize each object type, for example halftoning and color matching. Such methods, however, require the document objects to be fully rasterized by the printer driver (not shown), or the object type rendering hints must be passed with the print data (see 108) in a page description language (PDL) format, and the PDL format data must then be rendered again into a bitmap, which can then be rasterized, resulting in wasted processing resources and time.

FIG. 1b illustrates one modification of the above PDL approach. In accordance with the methodology of FIG. 1b, the classification of object type and assignment of object type-specific rendering methods is deferred to the printer firmware interpreter. In one mode, the print data 112 is passed to the printer in a page description language (PDL), which still preserves the object composition of the document. In that scenario, the firmware interpreter 114 can then classify and assign rendering methods on-the-fly, as the print data is being interpreted and rendered. See U.S. Pat. No. 6,256,104 and U.S. Pat. No. 6,275,304. The results 118 are input to the Raster Image Processor RIP 120. However, such methods impose serious limitations in that (1) the driver's print data composition of the document objects to print objects may not necessarily be a one-to-one match; and (2) the print data must be in a PDL format, once again requiring the printer to perform all of the rasterization function to produce the raster image 130.

Referring now to FIG. 1c, in another modification of the methodology above, the print data is first partially rasterized on the host into a bit map image(s) (e.g., color bitmap cover). The bitmap data is then sent to the firmware to complete rasterization. (The term “firmware” refers to software that generally is stored and executed in a printer or MFP device.) The firmware 136 that receives a bitmap page image 140 may perform image segmentation 144 to essentially “reverse engineer” the identification of objects 148. The objects are then tagged, per object type, with rendering hints 150, which in turn are used by the rendering and rasterizing firmware 152 to optimize the output quality in raster image 154. This method has limitations in that the firmware 136 must execute an expensive process to recover identification of objects in the bitmap image, and the segmentation generally does not result in completely accurate recovery of the original document objects, so fidelity is compromised.

Referring now to FIG. 1d, In another prior art method, the host side (e.g., driver) partially rasterizes the document objects into a color RGB bitmap. In addition, it forms a 4^{th} extra plane (e.g., RGBX), where the 4^{th} plane is used to pass rendering hints derived from the document objects. In this manner, the firmware obtains the benefit of a faster performance and rendering hints, by not having to rasterize the document objects into bitmap data, and not having to reverse engineer (e.g. segmentation) the rendering hints. The downside here is that the extra 4^{th} plane has to be sent as part of the bitmap, increasing its size by approximately 25%. For further detail see U.S. Patent Application Publication No. 2002/0076103. The need remains for improvements that overcome the limitations of the prior art in the use of graphic image rendering hints.

### SUMMARY OF THE INVENTION

In one aspect, the invention comprises a method for encoding rendering hints into a bitmap image. For example, a color bitmap driver receives a description of a digital document in which the description defines a plurality of print objects. The bitmap driver converts the print objects into a plurality of internal objects. It further derives a corresponding rendering hint for each internal object for use in rendering the document on an output device. The method then calls for tagging at least one of the internal objects with the corresponding rendering hint; and finally, forming an output bitmap image of the received digital document.

Preferably, the bitmap image includes both the internal objects and the corresponding hints for each internal object that was tagged with a hint, yet the bitmap image is effectively no larger than a corresponding bit map without the embedded rendering hints. Examples of rendering hints may include, without limitation, edge detection, grayscale replacement levels, candidate spot color replacement, etc. The rendering hints may be used by printer firmware to determined amounts and types of under color removal, other ink reduction/replacement strategies, and halftoning algorithms. These determinations can be made on a per-object basis, where the internal objects assembled by the novel bitmap driver are not limited to a one-to-one correlation to the application or PDL level print objects. Various aspects of the invention can be used in application software, printer drivers, and the like. It can be used in a variety of operating environments including without limitation color MFP devices which can produce at least one type of hardcopy output. The output device firmware in a typical implementation recovers the rendering hints from the bitmap image and applies them to improve the quality of the output.

Additional aspects and advantages of this invention will be apparent from the following detailed description of preferred embodiments, which proceeds with reference to the accompanying drawings.

### BRIEF DESCRIPTION OF THE DRAWINGS

FIGS. 1a-1d are simplified diagrams illustrating various prior art systems and methods related to determining and using object type-specific rendering methods.

FIG. 2 is a simplified diagram illustrating one example of an operating environment in which the present invention may be used.

FIG. 3 is a simplified process flow diagram illustrating a presently preferred embodiment of the present invention.

FIG. 4 is a simplified process flow diagram illustrating an alternative embodiment of the present invention.

FIG. 5 is a simplified process flow diagram illustrating another alternative embodiment of the invention in the context of a direct image submit application.

FIG. 6 is a simplified process flow diagram illustrating recovery and processing of rendering hints in a firmware renderer process.

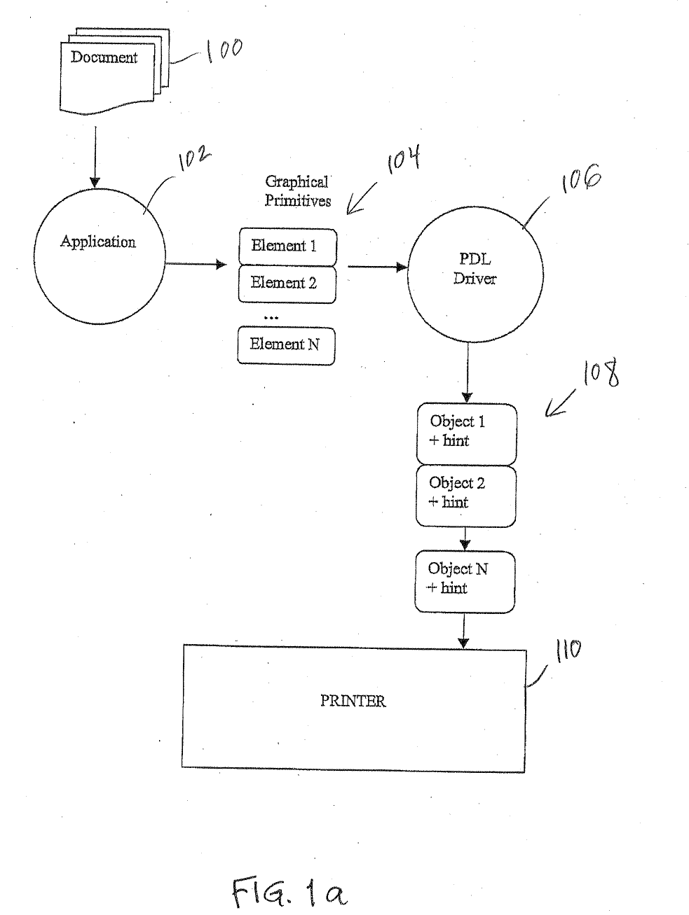

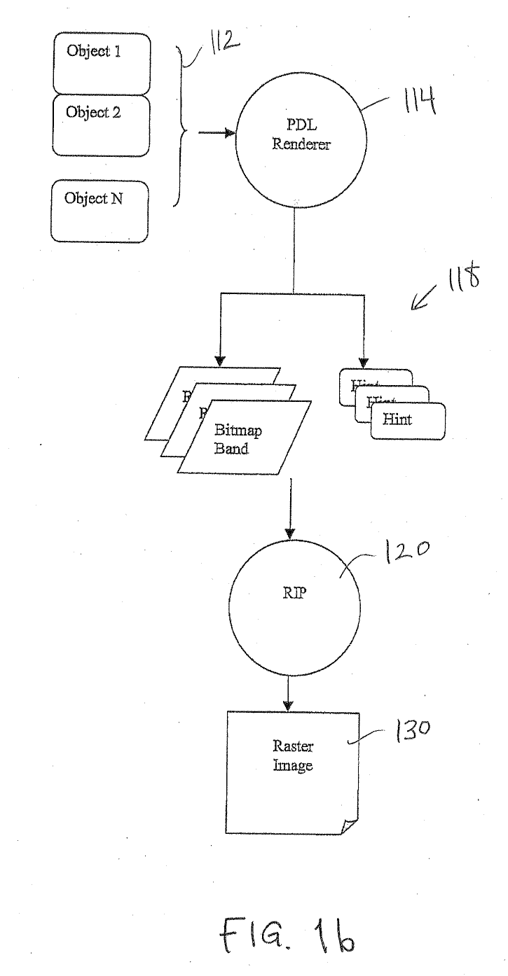

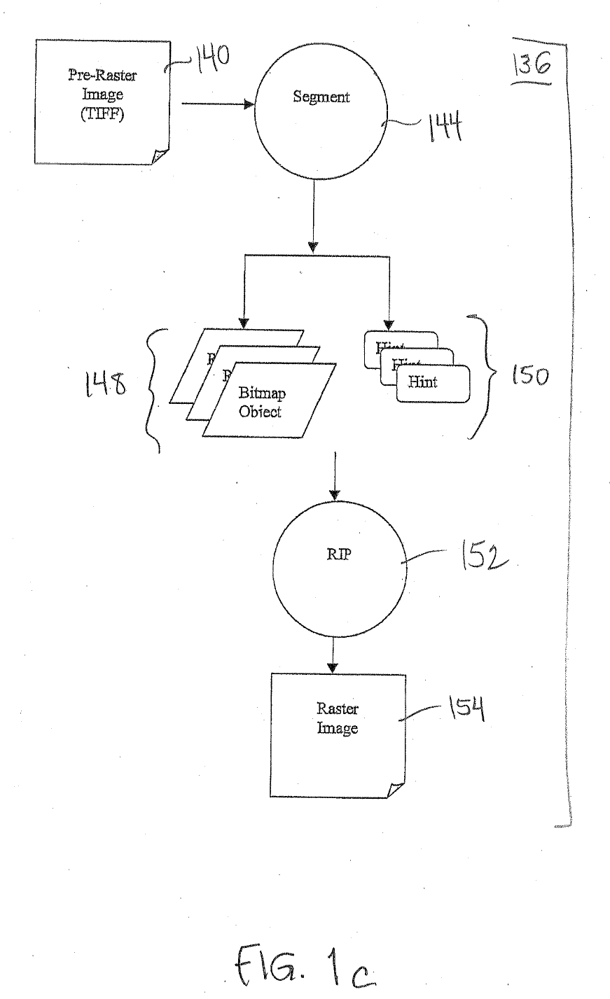

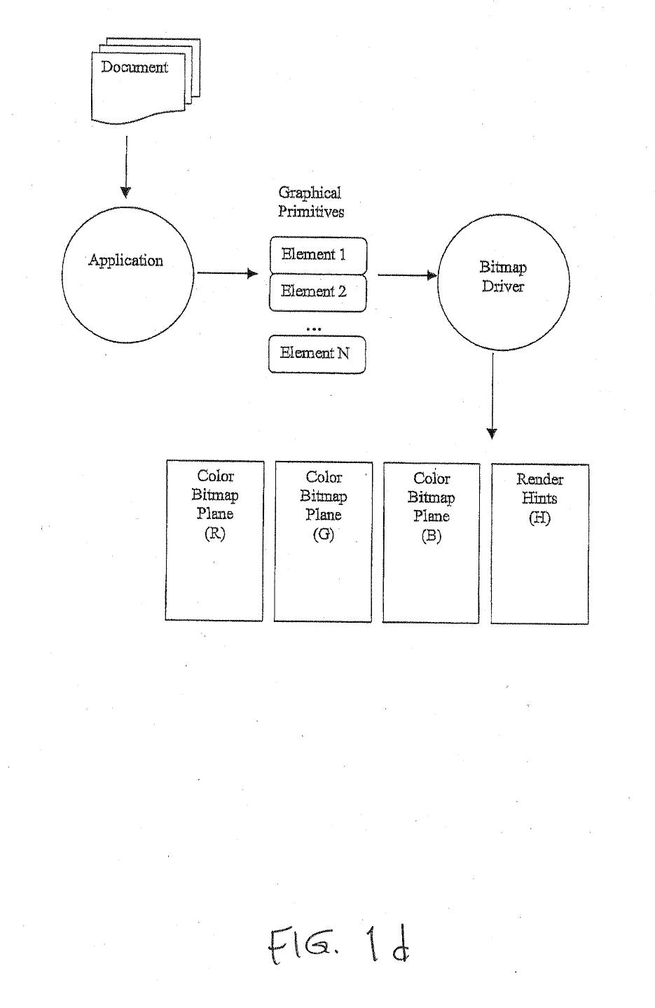

### DETAILED DESCRIPTION OF PREFERRED EMBODIMENTS

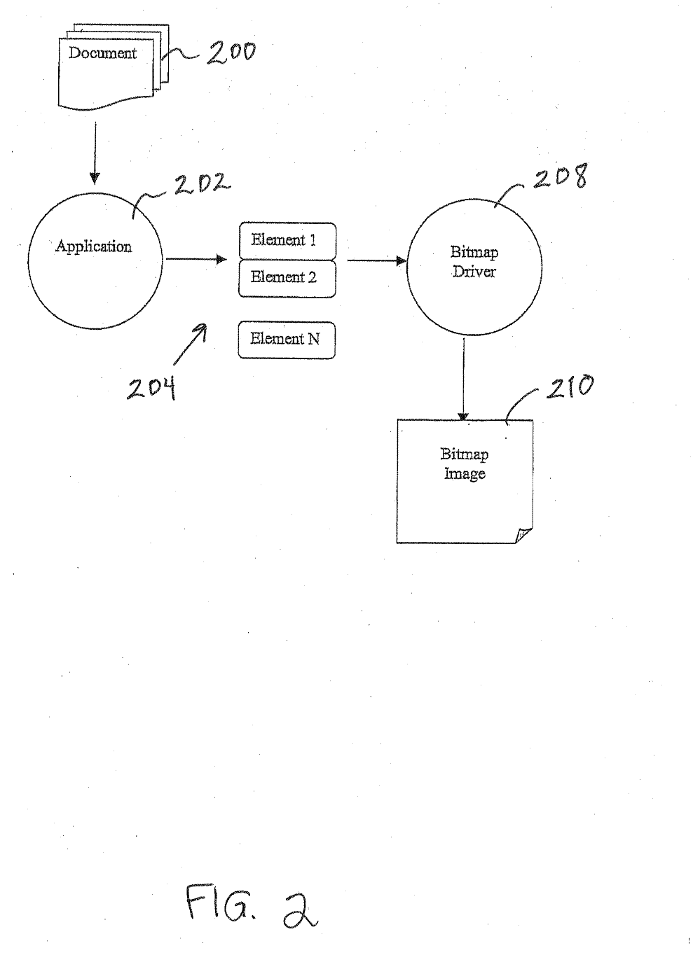

Referring now to FIG. 2, a simplified diagram illustrating one example of an operating environment is shown. A representative operating environment includes at least one color printer or color MFP (multi-function peripheral) device (not shown) that can produce a hard copy output. Hardcopy output in this context includes but is not limited to a print (on paper or other media), a fax, and a walkup hardcopy of a softcopy input, e.g., a walkup USB print. The color MFP may also support other imaging operations, to which features of the present invention can be applied as well. Other such operations include but are not limited to format conversion, scanning/OCR or other types of segmentation operations.

Referring again to FIG. 2, in some systems a print subsystem comprises an application 202 that can process a document 200 by converting each of the document's native formatted document objects into an equivalent print object. Examples include GDI and XPS. GDI is short for Graphical Device Interface, a Windows standard for representing graphical objects and transmitting them to output devices, such as monitors and printers. XPS refers to the “XML Paper Specification,” a specification for a page description language and a fixed-document format developed by Microsoft. It is an XML-based specification based on a new print path and a color-managed vector-based document format which allegedly supports device independence and resolution independence.

Examples of common document objects may include one or more of text strings, text strings of a specific size/font, vectors, vectors of certain width/fill, bitmaps, bitmaps of a certain grayscale or color. The present invention can be adapted, however, to follow technical advances in digital content compression/encoding, encryption, formatting and rendering methods, which may involve new or different document objects.

In one embodiment, print object data (labeled as elements 1-N) 204 are input to a color bitmap driver 208, implemented in software that is built or modified to operate as described herein. The driver 208 converts the print objects into a partially rasterized image, such as an RGB bitmap 210, as further described below. Preferably, the bitmap image 210 is device independent. The color bitmap driver is arranged to encode rendering hints relating to the original document objects (i.e., prior to conversion to bitmap). Additionally, the rendering hints may be added into the data without expanding the size or changing the format of the bitmap. Illustrative methods of doing so are described below, although they are not intended to be exhaustive.

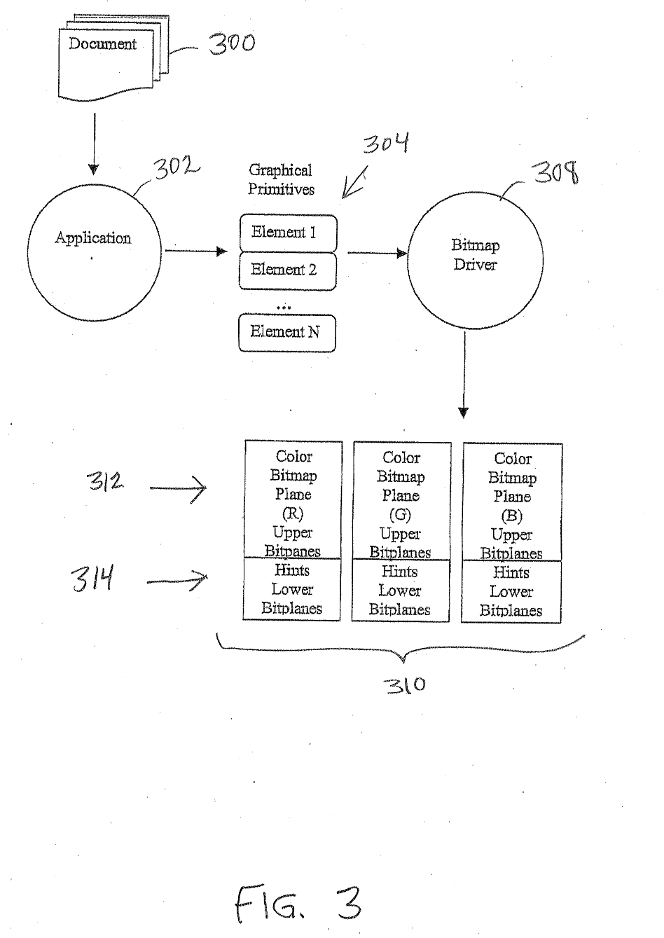

Referring now to FIG. 3, a simplified process flow diagram illustrates a preferred embodiment of the present invention. Here, an input digital document file 300 is created or processed by an application 302 that generates a set of graphical primitives or objects 304 as mentioned above. This object data is input to the bitmap driver 308, as noted, which produces a bitmap image 310 as follows. Rendering hints are generally determined by examination of the document objects passed to the driver to render into printer ready data. Some examples of document objects are given above.

In various embodiments, the color bitmap driver may recognize and or assemble one or more of the following print objects:
1. TEXT

a. Text characters

b. Words

c. Text lines

d. Text sentences

e. Text paragraphs

f. Enclosing text region.
2. VECTOR

a. Line segments

b. Text lines

c. Geometric shape

d. Composition of geometric shapes

e. Enclosing vector region.
3. BITMAPS

a. BW bitmap

b. Grayscale bitmap

c. Color bitmap

d. Color complexity

e. Color density.

Examples of rendering hints may include, without limitation, edge detection, percentage of UCR, halftone algorithm, image enhancement, percentage of color reduction, grayscale replacement levels, candidate spot color replacement, lossy v. lossless compression, etc. Details of these and other rendering processes and parameters are known. Any or all of the embedded rendering hints may be used by output device firmware to affect selections or otherwise control rendering. These determinations can be made on a per-object basis.

The internal objects assembled by the novel bitmap driver are not limited to a one-to-one correlation to the application or PDL level print objects. Rather, the conversion may be one-to-one, many-to-one, one-to-many or many-to-many. For example, a word processing application may parse a text sequence into print objects each consisting of a single character in the text sequence. The color bitmap driver may then either preserve the object resolution, or for example assemble sequences of individual characters into words. Thus the rendering hints are related to the original document objects, but may reflect a higher or lower resolution as to some or all objects, depending on the specific implementation. The bitmap driver then derives a corresponding rendering hint for each internal object for use in rendering the document on an output device or file. The method then calls for tagging at least one of the internal objects with the corresponding rendering hint; and finally, forming an output bitmap image.

In the illustration of FIG. 3, the bitmap image comprises three color planes, for example 8-bit color planes (red, green and blue), each including upper bitplanes 312 and lower bitplanes 314. This example is given by way of illustration and not limitation. The present invention is not limited to any particular format, number of color planes, or bit depth. Each bit plane represents a level of intensity of the primary color at a particular pixel location. The higher level (more significant) bit planes represent levels of increasing intensity, each one increasing by a factor of 2, in the well-known binary coding fashion. So, for example, in the 8-bit format, (2**8) or 256 levels can be represented.

Because the lower bit levels contribute the least amount of color (ink) intensity for a given pixel, the least significant 3 bits (the lower bitplanes) can be ignored as relatively low value information. In accordance with the present invention, these bit positions are not ignored, but instead are reused to embed rendering hints into the data. In general, dropping or ignoring the least significant 1 or 2 bitplanes from a bitmap will have no effect on the outcome when rendered into hardcopy. That is, the upper (more significant) bitplanes dominate the determination of color. By reusing the least significant or “low value” bits of the image, the rendering hints are added without expanding the size of the file or changing the format of the bitmap. Preferably, the output bitmap has a format compatible with one of TIFF, JPEG, PNG, GIF, BMP and WMF. However, the teachings of the present disclosure can be adapted to future file formats as the technology evolves.

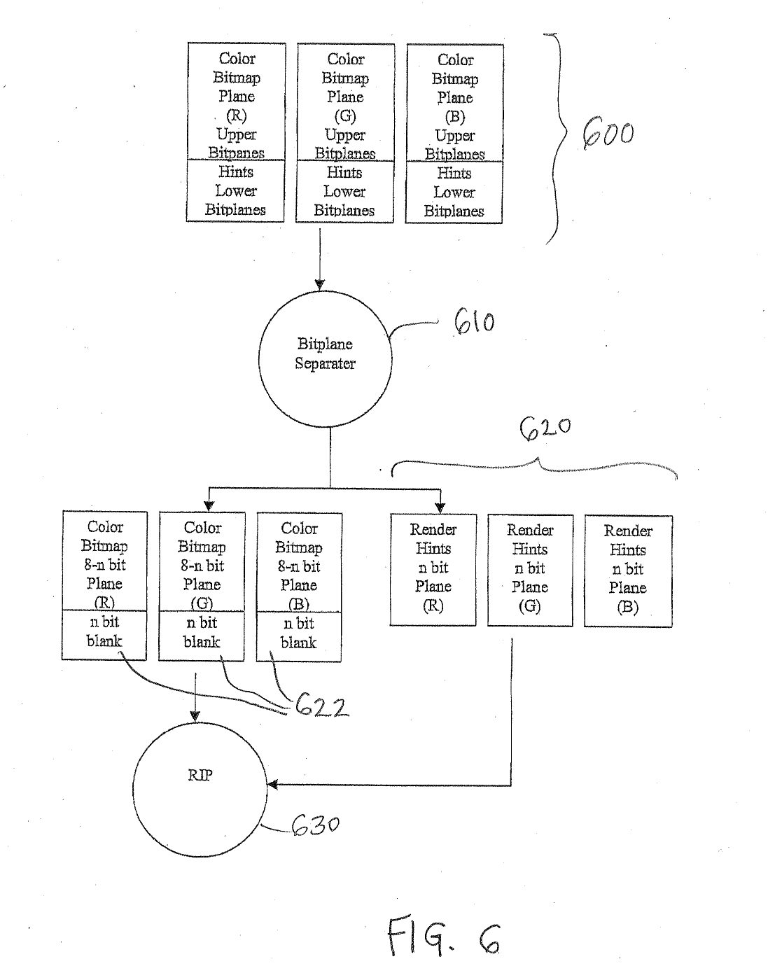

On the output (e.g., printer) side, firmware will then interpret pixel values on these bit planes as encoded rendering hints and not as color intensity. This is explained further below with regard to FIG. 6. Upgrading printer firmware to implement this feature is not difficult, using, for example, Internet downloads. On the other hand, because the standard bitmap formatting is preserved in a preferred embodiment, and no significant data is lost, the output bitmap file remains fully compatible with standard output devices and firmware, including legacy firmware that does not recognize the rendering hints.

The color bitmap driver 308 may select any number of color planes and bit planes within a color plane. The color bitmap driver may convey the selection of encoded color/bit planes to the firmware either implicitly (i.e., using a predetermined format or protocol), or explicitly, for example by passing the information with the print data. Examples of the latter include, without limitation, using a PJL (printer job language) or XPS Print Ticket commands.

In some embodiments, if the color bitmap and color MFP support a flexible use of the number of color/bit planes used for encoding the hints, the driver may choose the most minimal or otherwise optimal set for the totality of the information (i.e. rendering hints) to be encoded. For example, if the only rendering hint encoded is whether a pixel is part of an edge (say a line), the hint can be encoded as a single bit. In that case, the driver may choose to use only a single bit plane (i.e., least significant) within a single color plane. The driver may also select the color plane to use based on knowledge of the color MFP's color gamut conversion, to have the least impact on the rendering of the image. The selection of specific color/bit planes may be predetermined, configured by an administrator, or selected by the user.

When multiple rendering hints are to be encoded, the driver may select a single bit plane per each rendering hint, in other words bit flags, or employ an enumeration of all sensible combinations. For example, there may be two edge detection rendering hints, one indicating the pixel is part of a text character edge, and the other hint to indicate part of a line edge of a vector object. In this case, since a pixel cannot be both part of a text character and part of a line vector edge, four states (two full bits) are not needed. Instead, only three states are needed, namely off, text and vector.

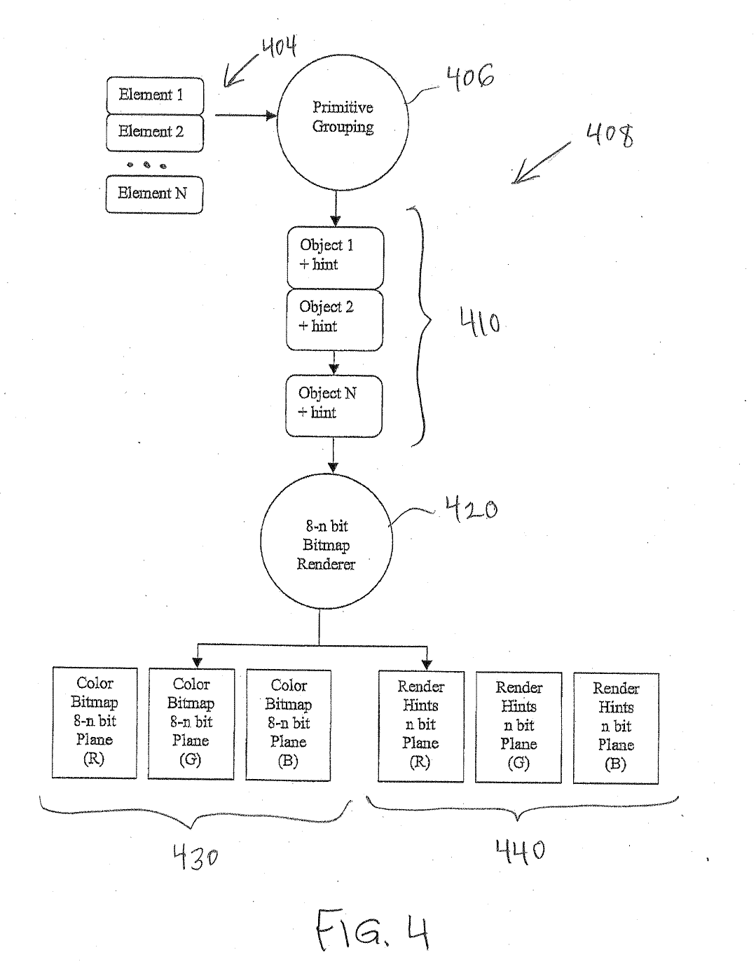

Referring now to FIG. 4, this is a simplified process flow diagram illustrating an alternative embodiment of the invention. Here, graphic primitives 404 (labeled Element 1 to Element N) are processed in the driver 408 preserving primitive grouping so as to form a set of N internal objects. As noted above, in other embodiments, the resolution may be higher or lower than the input graphic primitives. Each internal object 410 is assigned a corresponding rendering hint. This data then is input to an 8-n bit Bitmap Renderer process 420, where n refers to the number of bitplanes used for rendering hints. The driver renderer 420 renders the data into 8-n bit color planes 430 and uses lower n bits 440 for the corresponding driver based hints.

In one example, the lowest bitplane from each of three color planes is reused, providing three bits available to convey 8 states (rendering actions, parameters, attributes, etc.) associated with each pixel. If the lowest two bitplanes are used (times three colors), the present method can be used to convey up to 64 (2**6) states.

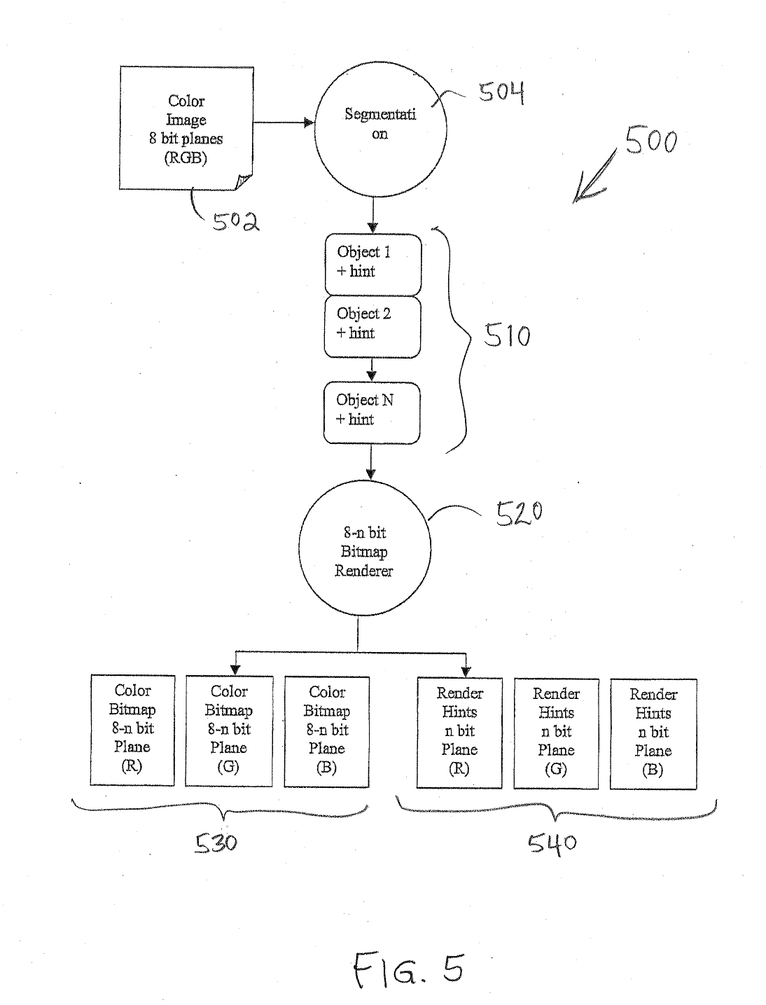

Referring now to FIG. 5, this is a simplified process flow diagram illustrating another alternative embodiment of the invention in a direct image submit application. Here, the document (input) is already a bitmap image 502, such as scanned image data obtained from a hardcopy scanner. Typically, the image data is directly submitted to the color MFP using a direct submit application (DSA). The DSA performs many functions of a traditional driver (e.g., communicating job control instructions), but it does not convert the document data (i.e., image data) into printer ready data. In this application, however, an improved DSA 500 will attempt to determine the document objects by image segmentation 504. Various methods of image segmentation are known. See, for example, “Method and Apparatus for Segmenting an Image Using a Combination of Image Segmentation Techniques,” U.S. Patent Application Publication No. 2002/0076103, assigned to Xerox Corporation. Preferably, in the illustration of FIG. 5, the DSA 500 uses a combination of methods. For example, it may be arranged to identify regions of text, vectors and bitmaps, and then use secondary segmentation techniques to determine a finer resolution of document objects within those regions.

Once the segmentation process 504 determines the document objects within the bitmap image 502, the DSA 500 may then determine and encode rendering hints relating to the document objects, resulting in a set of objects and corresponding hints 510. This data then is input to an 8-n bit Bitmap Renderer process 520. The DSA renderer 520 renders the data into 8-n bit color planes 530 and uses lower n bits 540 for the corresponding hints as described above.

FIG. 6 is a simplified process flow diagram illustrating recovery and processing of rendering hints in a firmware renderer process. Here, the firmware, e.g., in a color MFP, receives a bitmap 600 encoded with rendering hints. The MFP determines the location of the rendering hints, either implicitly or explicitly, as explained above. Once the location is determined, the firmware extracts the rendering hint information in a bitplane separator process 610. The rendering hints n bit planes 620 are input to the Raster Image Processor RIP 630. Additionally, the encoded color/bit planes may be masked out from the rendering operations as indicated at 622. The resulting color bitmap planes are input to the RIP with the corresponding extracted hint data to be rasterized into engine ready data, such as a CMYK image which has been halftoned/color converted for a specific printing/marking engine. The rendering hints may be used by the rasterization process to affect how corresponding pixels are rendered.

It will be obvious to those having skill in the art that many changes may be made to the details of the above-described embodiments without departing from the underlying principles of the invention. For example, while the preferred embodiments describe a bitmap print job being converted to a hard copy output, other embodiments may cover softcopy outputs, such as an outbound fax, format conversion, or a filing job. The scope of the present invention should therefore, be determined only by the following claims.

1. A digital document processing system comprising:
an application for creating a digital document and providing document data comprising a plurality of print objects;
a color bitmap driver for receiving the print objects and forming a set of internal objects responsive to the print objects;
the color bitmap driver producing a bitmap output image of the internal objects, the bitmap output image including embedded rendering hints; and
an output device, the output device arranged to execute a firmware process to receive the bitmap image from the color bitmap driver, extract the embedded rendering hints from the bitmap image, and apply the extracted rendering hints in rendering the bitmap image data into output device engine ready data.

2. A digital document processing system according to claim 1 wherein the output device comprises one of an MFP device, a softcopy device and a hardcopy device.

3. A digital document processing system according to claim 1 wherein:
the application is deployed on a host computer coupled to a network;
the output device is coupled to the network to receive the bitmap image data; and
the color bitmap driver is implemented as a software process executable on the host computer.

4. A digital document processing system according to claim 1 wherein the rendering hints are embedded into the bitmap image by reusing at least one of the least significant color bit planes so that the bitmap image size is not increased by the rendering hint data.

5. A method for encoding rendering hints into a bitmap image, the method comprising:
receiving a description of a digital document in which the description defines a plurality of print objects;
converting the print objects into a plurality of internal objects;
for each internal object, deriving a corresponding rendering hint for use in rendering the document on an output device;
tagging at least one internal object with the corresponding rendering hint; and
forming an output bitmap image of the received digital document, the bitmap image including both the internal objects and the corresponding rendering hints for each internal object that was tagged with a hint.

6. A method according to claim 5 including embedding the rendering hints into the output bitmap image without expanding the bitmap image beyond a predetermined size.

7. A method according to claim 6 including:
selecting a number of color planes of the output bitmap image;
selecting a number of bit planes within each color plane; and
conveying the selection of the number of color planes and bit planes to an output device by including indicia of said selections within print data transmitted to the output device.

8. A method according to claim 5 including embedding the rendering hints into the output bitmap image by reusing existing areas of the bitmap that would otherwise contain low value information.

9. A method according to claim 5 wherein the output bitmap image is in a device independent format, with a standardized reference color space.

10. A method according to claim 9 wherein the output bitmap image is in an sRGB format.

11. A method according to claim 5 wherein the output bitmap has a format compatible with one of TIFF, JPEG, PNG, GIF, BMP, EXIF and WMP.

12. A method according to claim 5 wherein:
the output bitmap image comprises three color planes, each color plane including upper bitplanes and lower bitplanes;
the upper bitplanes contain image data; and
the lower bitplanes contain rendering hint data.

13. A method according to claim 5 wherein said converting the print objects into a plurality of internal objects results in a modified object resolution.

14. A method according to claim 5 wherein the rendering hints indicate at least one of edge detection, percentage of UCR, halftone algorithm, image enhancement, percentage of color reduction, grayscale replacement levels, and candidate spot color replacement.

15. A firmware program comprising executable code stored in machine-readable media for execution in a processor of a document output device, the firmware program including:
code to receive input bitmap image data;
code to render the input bitmap image data into raster output data; and
code to extract rendering hint data from at least one lower bitplane of the input bitmap image data; and
wherein the extracted rendering hint data is used as input to the rendering code to render the input bitmap image data into the raster output data.

16. A firmware program according to claim 15 wherein the code is arranged for operation in a processor of a multi-function peripheral MFP device.

17. A firmware program according to claim 15 wherein:
the input bitmap image comprises multiple color planes, each color plane including upper bitplanes and lower bitplanes;
the upper bitplanes contain image data; and
the lower bitplanes contain the rendering hint data.

18. A firmware program according to claim 17 wherein the code is arranged for operation in a processor of a printer.

19. A firmware program according to claim 17 wherein the rendering hints are used by the printer firmware to determine one or more of amounts and types of under color removal, other ink reduction/replacement strategies, and halftoning algorithms.

20. A firmware program according to claim 17 wherein the rendering hints are used by the printer firmware to select a color gamut conversion.
